(19) United States
(12) Patent Application Publication
(10) Pub. No.: US 2009/0191344 A1
(43) Pub. Date: Jul. 30, 2009

(54) Method for waterproofing wood

(76) Inventor: Christian Herzig, (US)

Correspondence Address: BROOKS KUSHMAN P.C., 1000 TOWN CENTER, TWENTY-SECOND FLOOR, SOUTHFIELD, MI, 48075, US

(21) Appl. No.: 12/438,309

(22) PCT Filed: Aug. 6, 2007
(86) PCT No.: PCT/EP2007/058142

§ 371 Date: Feb. 20, 2009

(30) Foreign Application Priority Data
Aug. 25, 2006 (DE) 10 2006 039 944.7

(51) Int. Cl. C08L 83/04; B05D 3/10

(52) U.S. Cl. 427/303; 525/474

(57) ABSTRACT

Wood and wood products are rendered water repellant by treating the wood or wood product with a combination of compounds containing at least three amino groups at least one being a primary amino group, and a low surface tension β-ketocarbonyl-functional siloxane polymer.

The invention relates to a method for waterproofing wood.

US 2004/0118540 A1 describes a papermaking process in which first a high molecular amine component having an NH₂ concentration of at least 1.5 meq/g is added to an aqueous cellulose fiber mixture. Separately therefrom, a second component which can react with amino groups and which is either a polyanionic compound or an aldehyde-functional polymer is then added. By means of the two-component system, the wet strength of the paper products, such as paper towels, is increased.

A paper product, such as paper towels, having increased wet strength is claimed in U.S. Pat. No. 6,824,650 B2. The product contains a combination of a polyvinylamine and a complexing agent selected from an aldehyde-functional polymer and a polyelectrolyte. By reaction of polyvinylamine with the complexing agent, the paper product is strengthened.

Articles which contain cellulose, of which at least a part was chemically modified, and wherein a further chemical has formed chemical bonds, are claimed in U.S. Pat. No. 6,916,402 B2. The chemical modification of the cellulose can be carried out with compounds which contain aldehyde, epoxy or anhydride groups, while the further chemicals then contain amine, thiol, amide, sulfonamide or sulfinic acid groups—or vice versa.

The additives described in the prior art serve for increasing the wet strength of paper articles, such as paper towels, so that the paper towels absorb liquids, such as water, but do not tear thereby. It is therefore not desirable to make paper articles waterproof.

It was the object to provide a method for waterproofing wood products produced from wood, in which the wood and the products produced from wood are protected from the influence of water and moisture and the treated wood has water-repellant properties.

The invention relates to a method for waterproofing wood with a combination of
(1) compounds which contain at least three amino groups, of which at least one amino group is a primary amino group, and
(2) β-ketocarbonyl-functional siloxane polymers which contain at least one trivalent radical B of the general formula

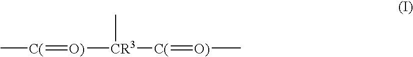

in which
R³ is a hydrogen atom or a monovalent hydrocarbon radical having 1 to 30 carbon atoms, preferably a hydrogen atom, with the proviso that the siloxane polymers (2) have a surface tension of not more than 40 mN/m, preferably not more than 35 mN/m and more preferably not more than 30 mN/m.

Here, the expression “wood” is not limited to solid wood, such as, for example, fir, spruce, alder, beech, pine, oak, poplar, lime, willow, maple, cedar, birch, hevea, cherry, larch, juniper, yew, robinia, elm, walnut, mahogany, palisander, teak, merbau, red cedar, olive, ash, wenige, kambala, afzelia, bongoso, iroko, makore, sipo, thuja, Douglas fir, khaja, pitch pine, sapelli, etc. The expression also comprises products produced from wood, such as particle boards, boards comprising wood particles and woodchips (particle boards, chip boards), fiber boards, such as, for example, LDF, MDF, HDF (low, medium and high density fiber board), HB (hard board), MBH, MBL (high density and low density medium boards), SB (soft boards), particle boards, such as, for example, OSB (oriented strand boards), plywood, laminated wood and veneer wood.

The compounds (1) may be silicon-containing, such as, for example, the aminopolysiloxanes which are known in the literature and contain aminopropyl, aminoisobutyl, 3-(2-aminoethylamino)propyl or 3-(2-aminoethylamino)-isobutyl groups. However, silicon-free organic polyamines are preferred, among which polymers of ethylenimine and hydrolyzed polymers of vinylformamide are particularly preferred.

The polyamines (1) preferably contain from 3 to 10 000, more preferably from 20 to 8000, amino groups, particularly preferably from 100 to 6000 amino groups, of which preferably from 2 to 6000 are primary amino groups, more preferably from 20 to 6000 are primary amino groups. Polyamines (1) may have a linear, branched or cyclic structure, it being possible for the primary amino functions to be arranged in a terminal or side position.

The polyamines (1) contain amino group concentrations in the range of, preferably, from 4 to 26 meq/g, more preferably from 13 to 26 meq/g (meq/g=mequivalent per g of substance=equivalent per kg of substance).

The siloxane polymers (2) may have an oligomeric or polymeric structure.

In the radical B in formula (I), preferably not more than one of the three free valencies are bonded to heteroatoms.

Preferably, the siloxane polymers (2) contain at least 2 radicals B per average molecule, preferably from 2 to 20 radicals B. The organic radicals B are bonded to the siloxane moiety of the siloxane polymers (2), preferably via Si—C groups.

Where the trivalent radical B is not bonded with any of the free valencies to heteroatoms, the siloxane polymers (2) according to the invention preferably contain at least one SiC-bonded radical B¹ selected from the group consisting of the general formulae

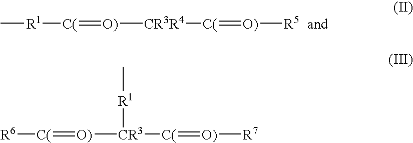

in which R³ has the meaning stated above therefor, R¹ is a divalent organic radical having 1 to 200 carbon atoms which, apart from in the terminal positions, may contain heteroatoms selected from the group consisting of oxygen, sulfur and nitrogen, preferably a hydrocarbon radical having 1 to 20 carbon atoms, more preferably a hydrocarbon radical having 1 to 4 carbon atoms,
R⁴ is a hydrogen atom or a hydrocarbon radical having 1 to 30 carbon atoms, preferably a hydrogen atom, and
R⁵, R⁶ and R⁷ are in each case a hydrocarbon radical having 1 to 30 carbon atoms.

The radicals B¹ of the formulae (II) and (III) have the structure of a substituted acetylacetone which is bonded via R¹ to a siloxane polymer.

Where the trivalent radical B is bonded with one free valency to heteroatoms, the siloxane polymers (2) according to the invention preferably contain at least one SiC-bonded radical B² selected from the group consisting of the general formulae

—R⁸—Y—C(O)—CHR³—C(═O)—CH₂R³ (IV)

and

—R⁸—Y—C(═O)—CR³═C(—OH)—CH₂R³ (V)

in which
Y is an oxygen atom or a radical of the formula —(NR⁹—R^{1′})_{z}—NR²—, preferably a radical of the formula —(NR⁹—R′)_{z}—NR²—, in which R′ is a divalent hydrocarbon radical having 1 to 6 carbon atoms, preferably a divalent hydrocarbon radical having 2 to 4 carbon atoms,
R² is a hydrogen atom or a hydrocarbon radical having 1 to 18 carbon atoms, preferably a hydrogen atom,
R³ has the meaning stated above therefor,
R⁸ is a divalent hydrocarbon radical having 1 to 200 carbon atoms which may contain heteroatoms selected from the group consisting of oxygen, sulfur and nitrogen, preferably a hydrocarbon radical having 1 to 20 carbon atoms, more preferably a hydrocarbon radical having 1 to 4 carbon atoms,
R⁹ is R² or a radical of the formula —C(═O)—CHR³—C(═O)—CH₂R³ or —C(═O)—CR³═C(—OH)—CH₂R³,
z is 0 or an integer from 1 to 10, preferably 0, 1 or 2, more preferably 0.

The radicals B² of the formulae (IV) and (V) are bonded to the siloxane polymer via radicals R⁸.

The radicals B² are preferred as radicals B.

The radicals B² of the formulae (IV) and (V) are tautomeric groups. Preferably, the siloxane polymers according to the invention contain at least 2 radicals B² from the group consisting of the formulae (IV) and (V) per molecule, it being possible for them to contain only radicals of the formula (IV), only radicals of the formula (V) or both together. Since tautomeric groups can be converted into one another, their respective content may change depending on external conditions. The quotient thereof can therefore vary within wide ranges and may be quotients of from about 1000:1 to about 1:1000.

The enol content of the siloxane polymers (2) according to the invention leads to a weakly acidic character of these substances, which depends sizably on the structural parameters and substituents of the group of the general formula (I). Preferably, this enolizable group has a pKa value of more than 5.0, particularly preferably of from 6.0 to 15.0, especially from 7.0 to 14.0.

Where the trivalent radical B is bonded with two free valencies to heteroatoms, the siloxane polymers (2) according to the invention preferably contain at least one SiC-bonded radical B³ selected from the group consisting of the general formulae

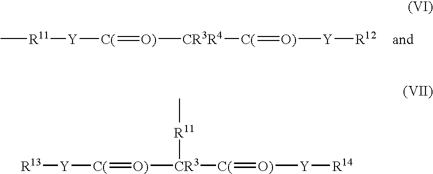

in which R³ and R⁴ have the meaning stated above therefor,
R¹¹ is a divalent organic radical having 1 to 200 carbon atoms which may contain heteroatoms selected from the group consisting of oxygen, sulfur and nitrogen, preferably a hydrocarbon radical having 1 to 20 carbon atoms, more preferably a hydrocarbon radical having 1 to 4 carbon atoms,
R¹², R¹³ and R¹⁴ have the meaning of R⁵, R⁶ and R⁷.

The siloxane polymers (2) according to the invention preferably contain from 5 to 5000 Si atoms, more preferably from 50 to 1000 Si atoms, per molecule. They may be linear, branched, dendrimeric or cyclic. Linear siloxane polymers (2) are particularly preferred.

Network structures of any desired size, with which neither a specific nor an average number of Si atoms can be coordinated, are also within the range of the siloxane polymers (2) according to the invention, provided that they preferably contain at least 2 functional groups B in the formula (I).

The β-ketocarbonyl-functional siloxane polymers (1) according to the invention are preferably organo-polysiloxanes comprising units of the general formula

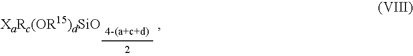

in which
X is an organic radical which contains the radical B, preferably an SiC-bonded radical B¹, B² or B³, where B, B¹, B² and B³ have the meaning stated above therefor,
R is a monovalent, optionally substituted hydrocarbon radical having 1 to 18 carbon atoms per radical,
R¹⁵ is a hydrogen atom or an alkyl radical having 1 to 8 carbon atoms, preferably a hydrogen atom or a methyl or ethyl radical,
a is 0 or 1,
c is 0, 1, 2 or 3 and
d is 0 or 1,
   with the proviso that the sum a+c+d is ≦3 and on average at least one radical X is present per molecule.

Preferred examples of the β-ketocarbonyl-functional siloxane polymers (1) according to the invention are organopolysiloxanes of the general formula

X_{g}R_{3-g}SiO(SiR₂O)ₗ(SiRXO)ₖSiR_{3-g}X_{g} (IXa)

and

(R¹⁵O)R₂SiO(SiR₂O)ₙ(SiRXO)ₘSiR₂(OR¹⁵) (IXb)

in which X, R and R¹⁵ have the meaning stated above therefor,
g is 0 or 1,
k is 0 or an integer from 1 to 30 and
l is 0 or an integer from 1 to 1000,
m is an integer from 1 to 30 and
n is 0 or an integer from 1 to 1000,
with the proviso that on average at least one radical X is present per molecule.

Examples of radicals R are alkyl radicals, such as methyl, ethyl, n-propyl, isopropyl, 1-n-butyl, 2-n-butyl, isobutyl, tert-butyl, n-pentyl, isopentyl, neopentyl, or tert-pentyl radical, hexyl radicals, such as the n-hexyl radical, heptyl radicals, such as the n-heptyl radical, octyl radicals, such as the n-octyl radical, and isooctyl radicals, such as 2,2,4-trimethylpentyl radical, nonyl radicals, such as the n-nonyl radical, decyl radicals, such as the n-decyl radical, dodecyl radicals, such as the n-dodecyl radical, and octadecyl radicals, such as the n-octadecyl radical; cycloalkyl radicals, such as cyclopentyl, cyclohexyl, cycloheptyl and methylcyclohexyl radicals; alkenyl radicals, such as the vinyl, 5-hexenyl, cyclohexenyl, 1-propenyl, allyl, 3-butenyl and 4-pentenyl radical; alkynyl radicals, such as the ethynyl, propargyl and 1-propynyl radical; aryl radicals, such as the phenyl, naphthyl, anthryl, and phenanthryl radical; alkaryl radicals, such as o-, m- and p-tolyl radicals, xylyl radicals and ethylphenyl radicals; and aralkyl radicals, such as the benzyl radical and the α- and the β-phenylethyl radical.

Examples of radicals R¹ are

—CH₂CH₂—, —CH(CH₃)—, —CH₂CH₂CH₂—, —CH₂C(CH₃)H—, —CH₂CH₂CH₂CH₂—, —CH₂CH₂CH(CH₃)— and —CH₂CH₂C(CH₃)₂CH₂—, the —CH₂CH₂CH₂— radical being preferred.

Radical R′ is preferably a radical of the formula —CH₂CH₂— and —CH₂CH₂CH₂—.

Examples of radicals R³ are alkyl radicals, such as methyl, ethyl, n-propyl, isopropyl, 1-n-butyl, 2-n-butyl, isobutyl, tert-butyl, n-pentyl, isopentyl, neopentyl, or tert-pentyl radical, hexyl radicals, such as the n-hexyl radical, heptyl radicals, such as the n-heptyl radical, octyl radicals, such as the n-octyl radical, and isooctyl radicals, such as 2,2,4-trimethylpentyl radical, nonyl radicals, such as the n-nonyl radical, decyl radicals, such as the n-decyl radical, dodecyl radicals, such as the n-dodecyl radical, and octadecyl radicals, such as the n-octadecyl radical; cycloalkyl radicals, such as cyclopentyl, cyclohexyl, cycloheptyl and methylcyclohexyl radicals; aryl radicals, such as the phenyl, naphthyl, anthryl, and phenanthryl radical; alkaryl radicals, such as o-, m- and p-tolyl radicals, xylyl radicals and ethylphenyl radicals; and aralkyl radicals, such as the benzyl radical and the α- and the β-phenylethyl radical.

Examples of hydrocarbon radicals R³ are also applicable for hydrocarbon radicals R².

Examples of hydrocarbon radicals R³ are also applicable for hydrocarbon radicals R⁴, R⁵, R⁶, R¹², R¹³, R¹⁴ and R¹⁴.

Examples of radicals R⁸ are

—CH₂CH₂—, —CH(CH₃)—, —CH₂CH₂CH₂—, —CH₂C(CH₃)H—, —CH₂CH₂CH₂CH₂—, —CH₂CH₂CH(CH₃)— and —CH₂CH₂C(CH₃)₂CH₂—, the —CH₂CH₂CH₂— radical being preferred.

Examples of radicals R¹¹ are the examples mentioned for radicals R⁸.

Examples of hydrocarbon radicals R¹⁵ are alkyl radicals, such as the methyl, ethyl, n-propyl, isopropyl, 1-n-butyl, 2-n-butyl, isobutyl, tert-butyl, n-pentyl, isopentyl, neopentyl and tert-pentyl radical, hexyl radicals, such as the n-hexyl radical, heptyl radicals, such as the n-heptyl radical, octyl radicals, such as the n-octyl radical, and isooctyl radicals, such as the 2,2,4-trimethylpentyl radical.

Further examples of siloxane polymers (2) used in the method according to the invention are resin-like structures, such as MQ resins, MTQ resins, MT resins, T resins, MDT resins, DT resins or MDQ resins.

Preferably, R in the siloxane polymers (2) of the formulae (VIII), (IXa) and (IXb) is a methyl radical. Further examples of siloxane polymers (2) used in the method according to the invention are those in which at least 10 mol %, preferably at least 20 mol % of the radicals R in the formula (VIII) are substituted by relatively long hydrocarbon radicals having at least 6 C atoms, preferably at least 8 C atoms and more preferably at least 12 C atoms. In the case of even longer substituents R having more than 18 C atoms, the compounds (2) achieve a waxy consistency.

The radicals B¹ of the formulae (II) and (III) are β-diketone groups which are bonded via R¹ to a siloxane polymer, either in a terminal position, based on the diketone (formula (II)) or to the C atom between the two carbonyl groups (formula (III)).

Methods for the preparation of β-ketocarbonyl-functional siloxane polymers (2) having radicals B¹ of the formula (II) are known from organic chemistry. They are preferably obtained via the acylation of acetoacetates with organosilicon compounds which contain Si-bonded acid chlorides. If, for example, siloxane polymers which contain Si-bonded undecanoyl chloride (R¹═—C₁₀H₂₀—) are reacted with ethyl acetoacetate (CH₃—C(═O)—CH₂—C(═O)—O—CH₂CH₃) (acylation) and CO₂ and ethanol are then eliminated thermally, siloxane polymers which contain radicals B¹ of the formula (II), with R¹═—C₁₀H₂₀—, R³═H, R⁴═H and R⁵=—CH₃, are obtained.

Methods for the preparation of β-ketocarbonyl-functional siloxane polymers (2) which contain radicals B¹ of the formula (III) are described in DE 1193504 A and DE 1795563 A. Here, the hydrosilylation of allylacetylacetone is preferred, siloxane polymers which contain radicals B¹ of the formula (III) with R¹═—C₃H₆—, R³═H, R⁶═R⁷═—CH₃ being formed. A preferred method is furthermore the alkylation of acetylacetone by siloxane polymers having Si-bonded halogen groups, such as —CH₂Cl, —CH₂Br, —C₃H₆Cl or —C₃H₆I.

Methods for the preparation of siloxane polymers (2) which contain radicals B² of the formulae (IV) and (V) are described in U.S. Pat. No. 6,121,404 A.

If Y in the formulae (IV) and (V) is a nitrogen-containing radical of the formula —(NR⁹—R′)_{z}—NR²—, which is preferred, the siloxane polymers (1) are preferably prepared by reacting diketenes (i) of the general formula

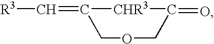

in which R³ has the meaning stated above therefor and is preferably a hydrogen atom,
with organosilicon compounds (ii) which contain at least one Si-bonded radical A of the general formula

—R⁸—(NR⁹—R′)_{z}—NR²₂ (XI)

per molecule, in which R⁸, R′, R², R⁹ and z have the meanings stated above therefor,
with the proviso that the radical A of the formula (XI) has at least one primary and optionally one secondary amino group, preferably at least one primary amino group.

The reaction is preferably effected in the presence of organic compounds (iii) which retard or prevent the reaction of primary or secondary amino groups with β-ketocarbonyl compounds, reacted.

Preferably used organic compounds (iii) are those which give more or less strong adducts with amines. Examples of compounds (iii) are aldehydes and ketones. Preferred examples are acetone, butanone, methyl isobutyl ketone and cyclohexanone.

In a preferred preparation method, organosilicon compounds (ii) are reacted with organic compounds (iii) in a 1st stage, the compounds (iii) forming protective groups on the amino groups in the radical A of the formula (XI), and the organosilicon compounds (ii) obtained in the 1st stage and having the protected amino groups (reaction products of (ii) and (iii)) then being reacted with diketenes (i) in a 2nd stage. In the reaction with diketene, the protective group is eliminated again from the amino group in the radical A of the formula (XI).

The radical A of the formula (XI) may also be an α-amino radical of the formula —CH₂—NR²—H. In this case, the concomitant use of organic compounds (iii) is not preferred in the preparation.

Examples of radicals A are

### —CH₂—NH₂

### —CH(CH₃)—NH₂

### —C(CH₃)₂—NH₂

### —CH₂CH₂—NH₂

### —CH₂CH₂CH₂—NH₂

### —CH₂CH₂CH₂CH₂—NH₂

### —CH₂CH₂CH(CH₃)—NH₂

### —CH₂CH₂CH₂—NH—CH₂CH₂—NH₂

### —CH₂CH₂CH₂—N(CH₃)—CH₂CH₂—NH₂

### —CH₂CH₂CH₂ [—NH—CH₂CH₂]₂—NH₂

### —CH₂CH₂C(CH₃)₂CH₂—NH₂,

where —CH₂CH₂CH₂—NH₂ and —CH₂CH₂CH₂—NH—CH₂CH₂—NH₂ are preferred.

Preferred examples of radicals B² are therefore

### —CH₂CH₂CH₂—NH(-Z),

### —CH₂CH₂CH₂—NH₁₋ₓ(-Z)ₓ-CH₂CH₂—NH(-Z),

where Z are radicals of the formulae

### —C(═O)—CHR³—C(═O)—CH₂R³ or

### —C(═O)—CR³—C(—OH)—CH₂R³,

R³ the meaning stated above therefor and is preferably a hydrogen atom and
x is 0 or 1.

Siloxane polymers (2) which contain radicals R³ of the formulae (VI) and (VII) are prepared, for example, by transesterification of malonic esters with carbinol-functional siloxanes or by C-alkylation of malonic esters with haloalkylsiloxanes.

The waterproofing of the wood can be effected in two different variants of the method.

In one variant of the method, the waterproofing of wood is effected by preferably treating the wood in

a first step
with polyamines (1),
and in a second step
with siloxane polymers (2).

After the treatment of the wood with polyamines (1) in the first step, the wood is preferably dried before the treatment of the wood in the second step with the siloxane polymers (2) is effected. The application of the siloxane polymers (2) in the second step is preferably effected only after the action of the polyamines (1) on the wood. The wood is then preferably dried after the second step.

In a second variant of the method, the waterproofing of the wood is preferably effected with a mixture of polyamines (1) and siloxane polymers (2), the mixture of polyamines (1) and siloxane polymers (2) being prepared before the treatment of wood. Thus, a premix of polyamines (1) and siloxane polymers (2) is first prepared and the mixture is then applied to the wood. After the treatment, the wood is preferably dried.

In the method according to the invention, polyamines (1) are used in amounts of, preferably, from 0.5 to 50 mol, more preferably 1.0 to 20 mol, of primary amino group per mole of radical B in the siloxane polymers (2).

The treatment of the wood can be effected in a manner known per se, such as in the pressure process, for example by full-cell impregnation, empty-cell impregnation, alternating-pressure impregnation, vacuum impregnation or a combination thereof; by sap replacement, for example by pressure-suction impregnation, suction tank impregnation, pressure-suction tank impregnation; by diffusion impregnation; by steeping, for example by impregnation of the base of the posts; by vacuum methods, by multiple vacuum methods, by combined pressure-vacuum methods and vacuum-pressure methods, by blowline methods; by brushing on; by immersion; by flooding, by pouring, by roller coating and by spraying or by a combination of known application methods.

The polyamines (1) are preferably used as aqueous solutions. Polyamines (1) are preferably present in amounts of from 1 to 50% by weight, preferably from 5 to 30% by weight, in the aqueous solutions.

The β-ketocarbonyl-functional siloxane polymers (2) are preferably used after dilution in organic solvents. Examples of organic solvents are isopropanol, toluene, n-hexane, xylene, benzine fractions, terpenes, methyl ethyl ketone, cyclohexanone, ethyl acetate, butyl diglycol, dipropylene glycol methyl ether, Kristallöl. Siloxane polymers (2) are preferably present in amounts of from 5 to 50% by weight, preferably from 5 to 30% by weight, in the solutions in organic solvents.

In addition to the compounds (1) and (2), still further additives which are usually concomitantly used in the treatment of wood can be concomitantly used. An example of further additives are tanning agents, fungicides, bactericides, preservatives, algicides, biocides, flameproofing agents, odorants and pigments.

The waterproofing of wood according to the invention or the drying of the treated wood is preferably carried out at temperatures of from 5 to 70° C., preferably from 10 to 50° C. The waterproofing according to the invention or the drying of the treated wood is preferably carried out at the pressure of the ambient atmosphere, i.e. at 1020 hPa, but can also be carried out at higher or lower pressures.

In the method according to the invention, the polyamines (1) and the siloxane polymers (2) are preferably used in each case in amounts of from 0.02 to 1 kg, more preferably from 0.05 to 0.5 kg, based on 1 m² of the wood to be waterproofed.

### EXAMPLE 1

a) 480 g of an aminopolysiloxane terminated with trimethylsilyloxy groups, comprising aminopropylmethylsilyloxy and dimethylsilyloxy units and having the amine number of 0.42 meq/g and a viscosity of 680 mm²/s (25° C.) are mixed with 24 g of acetone at 25° C. and stirred for 3 hours. 16.9 g of diketene are metered rapidly into this mixture, whereupon a moderately exothermic reaction results and the content of the flask heats up by 21° C. After one hour at about 45° C., the acetone is removed in vacuo and an acetoacetamidopropyl oil having a viscosity of 775 mm²/s (25° C.), an amine number of 0.01 meq/g and a concentration of 0.40 meq of acetoacetamide/g (¹H NMR) is obtained. The polymer contains on average 5.7 acetoacetamido groups per molecule, with a pKa value of about 11, and has a surface tension of 23 mN/m.

b) A two-stage method is used for impregnating a dried spruce wood board having the dimensions 200×100×16 mm, which was conditioned for 14 days at 25° C. and 50% relative humidity. 2.0 g of a 1% strength aqueous solution of polyvinylamine, obtainable as a 20% strength aqueous solution under the name Lupamin 9095 (BASF), is applied as uniformly as possible to one side of the test board (0.02 m²) using a fine brush. After drying in, the board is stored at 25° C. and 50% relative humidity for 24 hours.

In a second operation, 2.5 g of a 20% strength solution of the acetoacetamidosiloxane, prepared above under a), in isopropanol/toluene (1:1) are applied to the same side, once again as uniformly as possible, then dried in the air and stored for 24 hours. Spraying deionized water onto the test board placed obliquely at 45° shows very good beading effect. Good water repellency is achieved.

### EXAMPLE 2

As described in Example 1 under a), an acetoacetamidated MQ resin is prepared from 200 g of an amino-functional MQ resin dissolved in the same amount of toluene, 14 g of acetone and 8.8 g of diketene.

The amino-functional MQ resin consists of the units C₈H₁₇(CH₃)₂SiO_{0.5}, H₂N(CH₂)₃(CH₃)₂SiO_{0.5}, SiO₂ and C₂H₅OSiO_{1.5} and contains 0.522 mol of primary amino groups per kg of the resin and has an average molar mass Mₙ of 8700 Dalton. After the reaction with diketene, the acetone is removed together with toluene at 60° C. in vacuo, whereupon 209 g of a tacky silicone resin having an amine number of 0.015 meq/g and an acetoacetamide concentration of 0.45 meq/g is obtained. The resin contains on average about 4.2 acetoacetamido groups per molecule and has a surface tension of 31 mN/m.

As described in Example 1 under b), a spruce wood board is treated with Lupamin 9095 solution. In a second step, 2.0 g of a 20% strength solution of the acetoacetamide-MQ resin, prepared above under a), in n-heptane are then additionally applied uniformly, dried in the air and stored for 24 hours. Spraying of deionized water onto the test board placed obliquely at 45° shows a very good beading effect. Good water repellency is achieved.

1-12. (canceled)

13. A method for waterproofing wood or wood product substrates, comprising treating the substrate with a combination of
(1) at least one compound which contains at least three amino groups, of which at least one amino group is a primary amino group, and
(2) at least one β-ketocarbonyl-functional siloxane polymer which contains at least one trivalent radical B of the formula 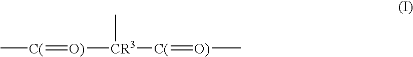
in which
R³ is a hydrogen atom or a monovalent hydrocarbon radical having 1 to 30 carbon atoms, with the proviso that the siloxane polymer(s) (2) have a surface tension of not more than 40 mN/m.

14. The method of claim 13, wherein R³ is H.

15. The method of claim 13, wherein the surface tension is not more than 35 mN/m.

16. The method of claim 13, wherein at least one organic polyamine is used as a compound (1).

17. The method of claim 13, wherein SiC-bonded radicals B¹ of the formulae 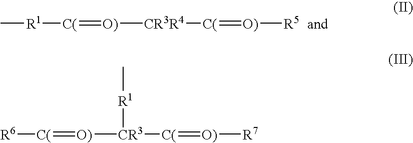
in which
R¹ is a divalent organic radical having 1 to 200 carbon atoms which, apart from in the terminal positions, optionally contain heteroatoms selected from the group consisting of oxygen, sulfur and nitrogen and mixtures thereof,
R³ has the meaning stated therefor in claim 1,
R⁴ is a hydrogen atom or a hydrocarbon radical having 1 to 30 carbon atoms, and
R⁵, R⁶ and R⁷ are in each case a hydrocarbon radical having 1 to 30 carbon atoms, are contained in the siloxane polymers (2) as a radical B.

18. The method of claim 17, wherein R¹ is a C₁₋₄ hydrocarbon radical.

19. The method of claim 13, wherein SiC-bonded radicals B² of the formulae
—R⁸—Y—C(═O)—CHR³—C(═O)—CH₂R³ (IV)
and
—R⁸—Y—C(═O)—CR³═C(—OH)—CH₂R³ (V)
in which
Y is an oxygen atom or a radical of the formula (NR⁹R′)_{z}—NR²,
in which R′ is a divalent hydrocarbon radical having 1 to 6 carbon atoms,
R² is a hydrogen atom or a hydrocarbon radical having 1 to 18 carbon atoms,
R⁸ is a divalent hydrocarbon radical having 1 to 200 carbon atoms which optionally contain heteroatoms selected from the group consisting of oxygen, sulfur and nitrogen,
R⁹ is R² or a radical of the formula —C(═O)—CHR³—C(═O)—CH₂R³ or —C(═O)—CR³═C(—OH)—CH₂R³,
z is 0 or an integer from 1 to 10,
are contained in the siloxane polymers (2) as a radical B.

20. The method of claim 19, wherein the radical B² is a radical of the formula
—CH₂CH₂CH₂—NH(-Z),
in which Z are radicals of the formulae
—C(═O)—CHR³—C(═O)—CH₂R³ or
—C(═O)—CR³—C(—OH)—CH₂R³.

21. The method of claim 13, wherein SiC-bonded radicals B³ of the formulae 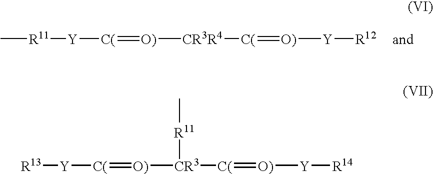
R¹¹ is a divalent organic radical having 1 to 200 carbon atoms which may contain heteroatoms selected from the group consisting of oxygen, sulfur and nitrogen and mixtures thereof,
R¹², R¹³ and R¹⁴ have the meaning of R⁵, R⁶ and R⁷, and R⁵, R⁶ and R⁷ are in each case a hydrocarbon radical having 1 to 30 carbon atoms,
are contained in the siloxane polymers (2) as a radical B.

22. The method of claim 13, wherein organopolysiloxanes comprising units of the formula 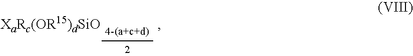
in which
X is an organic radical which contains the radical B,
R is a monovalent, optionally substituted hydrocarbon radical having 1 to 18 carbon atoms per radical,
R¹⁵ is a hydrogen atom or an alkyl radical having 1 to 8 carbon atoms,
a is 0 or 1,
c is 0, 1, 2 or 3 and
d is 0 or 1,
with the proviso that the sum a+c+d is ≦3 and on average at least one radical X is present per molecule,
are employed as at least one siloxane polymer (2).

23. The method of claim 13, wherein organopolysiloxanes of the formulae
X_{g}R_{3-g}SiO(SiR₂O)ₗ(SiRXO)ₖSiR_{3-g}X_{g} (IXa)
and
(R¹⁵O)R₂SiO(SiR₂O(SiR₂O)ₙ(SiRXO)ₘSiR₂(OR¹⁵) (IXb)
in which X, R and R¹⁵ have the meanings stated therefor in claim 6,
g is 0 or 1,
k is 0 or an integer from 1 to 30 and
l is 0 or an integer from 1 to 1000,
m is an integer from 1 to 30 and
n is 0 or an integer from 1 to 1000,
with the proviso that on average at least one radical X is present per molecule,
are used as siloxane polymers (2).

24. The method of claim 22, wherein the siloxane polymers (2) are MQ resins or MTQ resins and at least 10 mol % of the radicals R are hydrocarbon radicals having 6 to 18 carbon atoms.

25. The method of claim 13, wherein the substrate is treated in
a first step
with polyamine(s) (1),
and treated in a second step
with siloxane polymer(s) (2).

26. The method of claim 13, characterized in that the waterproofing of the substrate is effected with a mixture of polyamine(s) (1) and siloxane polymer(s) (2), the mixture of polyamines (1) and siloxane polymers (2) being prepared before the treatment of the substrate.

27. The method of claim 13, wherein the substrate is solid wood.
